(19) United States
(12) Patent Application Publication
(10) Pub. No.: US 2012/0246633 A1
(43) Pub. Date: Sep. 27, 2012

(54) ELECTRONIC BOOK AND SYSTEM FOR FIRMWARE UPGRADE OF ELECTRONIC BOOK

(75) Inventor: Hyoungki Nam, Seoul (KR)

(73) Assignee: LG INNOTEK CO., LTD., Seoul (KR)

(21) Appl. No.: 13/499,208

(22) PCT Filed: Sep. 29, 2010
(86) PCT No.: PCT/KR2010/006629

§ 371 Date: Jun. 8, 2012

(30) Foreign Application Priority Data
Sep. 29, 2009 (KR) 10-2009-0092250
Oct. 30, 2009 (KR) 10-2009-0104391

(51) Int. Cl. G06F 9/44; G06F 17/21

(52) U.S. Cl. 717/173; 715/243

(57) ABSTRACT

The present invention relates to an electronic book and system for firmware upgrade of electronic book, the system comprising: an electronic book terminal executing and installing an automatic upgrade program in a case terminal information, subscriber information and firmware version information are transmitted to a connected computer and version-up firmware is transmitted from the computer; and a computer obtaining terminal information, the subscriber information and firmware version by requesting the terminal information, the subscriber information and the firmware version from the electronic book terminal in a case the electronic book terminal is connected, receiving the subscriber information of the terminal from an upgrade sever and receiving a latest firmware from the upgrade server if the subscriber is identified by checking whether the subscriber information is matched, and downloading to the electronic book terminal.

### TECHNICAL FIELD

The present invention relates to an electronic book, and more particularly to an electronic book and system for firmware upgrade of electronic book capable of generating and storing, by a user, a memo when the user make a memo or a bookmark on contents of an electronic document displayed through an electronic book, checking a firmware version of an electronic book terminal (e-book), and automatically upgrading the firmware at a time necessitating the upgrade.

### BACKGROUND ART

An electronic book terminal (hereinafter referred to as “e-book”) is a device capable of showing to a user electronic information including paper printed book contents through display means, and allowing the user to read and edit the displayed information. That is, the e-book is imaginary means capable of rendering electronic documents stored in information storage means for the user to read per page. The electronic documents are provided commercially or non-commercially on networks such as internet, and can be downloaded to an e-book through the network and the e-book can obtain and store as new electronic documents.

Recently, concomitant with fast propagation and distribution of computers and internet, the electronic documents are now generalized form of life. Almost all the paper documents such as conventional books, notes, accounting books and the like are replaced by software electronic documents. The electronic documents can be easily copied, swiftly distributed regardless of geographic or time-wise limitation through communication networks and perfectly preserved to dispense with a large physical space for storage. Therefore, it is expected that manufacturing and distribution of electronic documents will gradually expand due to many advantages incomparable to those of the conventional paper documents.

The mobile phones, PDAs (Personal Digital Assistants) and personal computers may be used as an e-book. That is, any device may be an e-book as long as visually-readable electronic documents are digitalized in a given format, readable from a stored recording medium and displayed.

Under this circumstance, a device may be needed to effectively store and manage memorized information in a case a user makes a memo on a particular position of the electronic documents while viewing displayed electronic documents.

Conventionally, the e-book provides various functions by being mounted with operation system software for executing basic functions and application software for providing additional functions by being driven on the operation system software. The software (hereinafter referred to as “firmware”) is stored and retained in inflammable memory such as flash memory by preventing relevant software from being deleted even during the power-off situation.

Meanwhile, because the software of the e-book can satisfy various demands by the user and can be rapidly up-versioned for improving the system performances, there is a need of upgrading operation for replacing the software mounted on the e-book to a latest version. As a result, the firmware of the conventional e-book has been manually upgraded by using SD memory card or USB memory.

The manual upgrading suffers from disadvantage in that the user must be aware of or determine a timing of upgrading due to the fact that an accurate necessary upgrading timing cannot be precisely known. As a result, the e-book doesn't work properly.

### DISCLOSURE OF INVENTION

### Technical Problem

The present invention is disclosed to provide an electronic book that is not affected by layout changes of electronic documents by remembering a position per unit word of relevant electronic documents or texts in a case a user makes a memo on the contents of the electronic documents of texts displayed via electronic book.

The present invention is also disclosed to provide a firmware upgrade system of electronic book capable of automatically downloading firmware to an e-book in a case upgrade of firmware is needed after checking the version of firmware stored in the terminal through certification of the e-book.

The disclosed technical concepts should not be construed as limited to those set forth herein. Other technical concepts not disclosed herein may be well understood and apparent to those skilled in the art having the benefit of the teachings herein.

### Solution to Problem

The present invention is disclosed to solve the aforementioned problems and it is an object of the present invention to provide an electronic book and system for firmware upgrade of electronic book.

In one general aspect of the present invention, an electronic book may comprise: an electronic document storage stored with electronic document files; a memo storage stored with memo information per list including a memo or a bookmark content and position information thereof inputted based on the electronic documents; display means displaying the electronic documents per page; and a controller controlling in such a manner that the electronic documents stored in the electronic document storage are laid out per page and displayed, and selectively receiving memo content of the displayed electronic documents, adding position information including a paragraph number of relevant electronic document to the inputted memo content and storing in the memo storage.

In some exemplary embodiment, the position information may comprise at least any one of an electronic document name, a paragraph number and a memo subjected word, and the electronic document laid out per page may include a current page number, the number of an entire page, paragraph numbers of relevant pages and start address information.

In some exemplary embodiment, the controller may comprise: a layout generator laying out per page the electronic documents stored in the electronic document storage based on a pre-set screen standard or a user set-up; a memo maker displaying a memo input window based on a memo making command inputted from outside, adding a memo content inputted through the memo input window to the electronic document name and the paragraph number, and storing in the memo storage.

In another general aspect of the present invention, a system for firmware upgrade of electronic book may comprise: an electronic book terminal transmitting terminal information, subscriber information and version information of firmware to an accessed computer, and executing and installing an automatic upgrade program in a case version-up firmware is transmitted from the computer; an upgrade server transmitting to the computer the subscriber information matching to terminal information of the electronic book terminal and latest firmware version information to the computer in response to the accessed computer request, and a computer obtaining terminal information, the subscriber information and firmware version by requesting the terminal information, the subscriber information and the firmware version from the electronic book terminal in a case the electronic book terminal is connected, receiving the subscriber information of the terminal information from an upgrade sever to check whether the subscriber information is matched, and receiving a latest firmware from the upgrade server if the subscriber information is matched, and downloading to the electronic book terminal.

In some exemplary embodiment, the terminal information may comprise at least any one of a serial number of the terminal and modem number, and the subscriber number may comprise at least any one of an ID (identification), a password and a residential registration number.

In some exemplary embodiment, the computer may receive version information of the latest firmware from the upgrade server before downloading the latest firmware from the upgrade server to compare the version information of the latest firmware with firmware version of the electronic book terminal, and request the download of the latest firmware from the upgrade server if needs be.

In some exemplary embodiment, the computer may comprise: a subscriber authenticator comparing the subscriber information transmitted from the electronic book terminal with subscriber information of the terminal transmitted from the upgrade server and determining whether to match therebetween; a version checker comparing the firmware version transmitted from the electronic book terminal with the latest firmware version transmitted from the upgrade server and determining whether to match therebetween; and a downloader receiving the latest firmware from the upgrade server to transmit to a relevant electronic book terminal if upgrade is needed as a result of comparison of the firmware versions.

In still another aspect of the present invention, a system for firmware upgrade of electronic book may comprise: an electronic book terminal connecting to an upgrade server through a wireless communication network and transmitting the stored terminal information, the subscriber information and firmware version information to an upgrade server to request a firmware upgrade, and executing and installing an automatic upgrade program in a case the version-up firmware is transmitted from the upgrade server; and the upgrade server comparing the subscriber information from the electronic book terminal with the subscriber information of the terminal stored in the database in a case the terminal information, the subscriber information and the firmware version are transmitted from the electronic book terminal and checking whether to match therebetween, and comparing the firmware version installed in the electronic book terminal with a latest firmware version if the subscriber information is matched, and transmitting the latest firmware to the electronic book terminal if there is any need of upgrading.

In some exemplary embodiment, the upgrade server may comprise: a subscriber authenticator comparing the subscriber information transmitted from the electronic book terminal with subscriber information of the terminal stored in the database and determining whether to match therebetween; a version checker comparing the firmware version information transmitted from the electronic book terminal with the latest firmware version stored in the database and determining whether to match therebetween; and a downloader extracting the latest firmware from the database to transmit to a relevant electronic book if upgrade is needed as a result of comparison of the firmware versions.

### Advantageous Effects of Invention

The present invention is advantageous in that the electronic book can manage a plurality of memo lists in one folder structure to enable a package display of the memo lists and an effective memo inspection.

There is another advantage in that the memo information can be memorized per paragraph number and word unit to dispense with additional memo or bookmark design even if the number of pages is changed due to layout change of the electronic documents, thereby providing a management efficiency of memo information and convenience in the layout change.

There is still another advantage in that, in a case an electronic book terminal is accessed to a computer or an upgraded server, a firmware version stored in the terminal can be checked after a subscriber certification and if there is any upgrade of firmware, the latest firmware is automatically transmitted to the electronic book terminal to enable the latest firmware to be easily installed to the advantage of user convenience.

### BRIEF DESCRIPTION OF DRAWINGS

FIG. 1 is a schematic view illustrating a structure of a content storage related to the present invention.

FIG. 2 is a functional block diagram illustrating an electronic book terminal according to an exemplary embodiment of the present invention.

FIG. 3 is a schematic view illustrating a layout of electronic document and layout information per page of the electronic document according to the present invention.

FIG. 4 is a schematic view illustrating structure of content storage and memo information according to the present invention.

FIG. 5 is a schematic view illustrating a page screen of electronic document.

FIG. 6 is a schematic view illustrating a system for firmware upgrade according to another exemplary embodiment of the present invention.

FIG. 7 is a block diagram illustrating detailed configuration of the electronic book terminal of FIG. 6 according to an exemplary embodiment of the present invention.

FIG. 8 is a procedural view illustrating an upgrade process of FIG. 6 according to an exemplary embodiment of the present invention.

FIG. 9 is a schematic view illustrating a system for firmware upgrade according to another exemplary embodiment of the present invention.

FIG. 10 is a procedural view illustrating an upgrade process of FIG. 9 according to an exemplary embodiment of the present invention.

### BEST MODE FOR CARRYING OUT THE INVENTION

The exemplary embodiments of the present invention will be described in detail with reference to the accompanying drawings, where like reference numerals refer to like parts throughout the description of several views of the drawings. In describing the present invention, detailed descriptions of constructions or processes known in the art may be omitted to avoid obscuring appreciation of the invention by a person of ordinary skill in the art with unnecessary detail regarding such known constructions and functions.

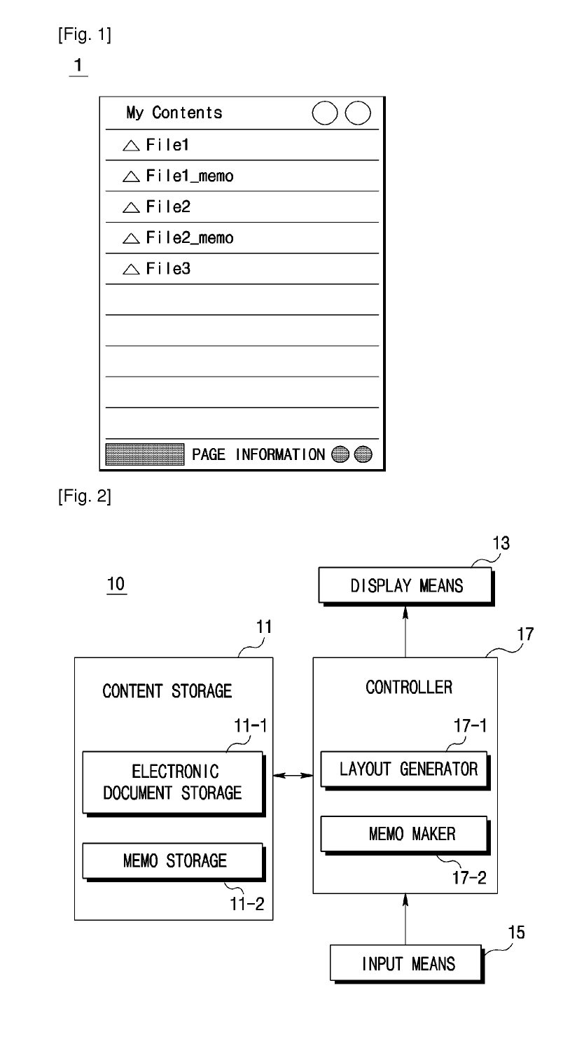

FIG. 1 is a schematic view illustrating a structure of a content storage related to the present invention.

Referring to FIG. 1, a content storage (1) of an electronic book may include electronic document files (File1, . . . ) and separate memo files (File-memo, . . . ) for each electronic document file. That is, the content storage (10) includes electronic document files and memo files or bookmark files matching to relevant electronic document files (hereinafter referred to as “memo files”) to enable a management of the memo files for each electronic document.

In making a memo or a bookmark of a particular portion of electronic document in the electronic book, memo information is stored through a separate memo file according to memory of a memo position, and the stored memo information is reloaded if necessary. The memo information may include memo content, an electronic document name, and page information.

In the conventional memo or bookmark method, two files included the same contents within a memory region exist and in a case a user deletes the memo or the bookmark in the electronic document, the memo file may disappear, and in a case the layout of the electronic book is reflowed by changing the letter sizes or line intervals, the page may be changed to twist the memo position, the problem of which must be urgently corrected.

FIG. 2 is a functional block diagram illustrating an electronic book terminal according to an exemplary embodiment of the present invention, where an electronic book (10) may include a content storage (11), display means (13), input means (15) and a controller (17).

The content storage (11) stored with electronic document files and memo files of the electronic documents may be divided into electronic document storage (11-1) and memo storage (11-2).

The ‘memo’ employed in the present invention may include not only the memo but also a bookmark. The electronic document storage (11-1) may be stored with electronic document files comprising a header and a body. The header may comprise basic information including a subject, an author, a year of writing, a total number of bytes and the publisher name, and the boy may comprise content of the electronic documents.

The memo storage (11-2) may be stored with memo information per list that includes memo content inputted based on the electronic document, and position information of the memo content, where the position information may include an electronic document name, a paragraph number and a memo subjected word.

The electronic document storage (11-1) and the memo storage (11-2) may be allocated into a different region within one memory or may be comprised of mutually different memories.

The display means (13) changes the document per page stored in the electronic document storage (11-1) according to scale of the display and displays the changed document. The input means (15) may be comprised of a keypad or a touch pad inputting commands such as a memo set-up of displayed electronic document, a memo preparation, a page up/down, a letter size and line interval. The controller (17) controls in such a manner that electronic documents stored in the electronic document storage (11-1) are laid out per page, stored and displayed, and selectively receives the memo content of the displayed electronic documents, and adds the position information of relevant electronic documents to the inputted memo content and stores in the memo storage (11-2). The position information may include at least any one of an electronic document name, a paragraph number and a word. To be more specific, the controller (17) may include a layout generator (17-1) and a memo maker (17-2).

The layout generator (17-1) may lay out the electronic documents stored in the electronic document storage (11-1) per page according to a pre-set screen size or a user set-up and temporarily store the electronic documents in a different memory region of the electronic document storage (11-1). The memo maker (17-2) may display the memo input window in a case a memo preparation command is inputted from input means (15), and add the memo content inputted through the memo input window to the position information. Furthermore, the memo maker (17-2) may underline a word to show whether the word has been highlighted by memo and bookmark.

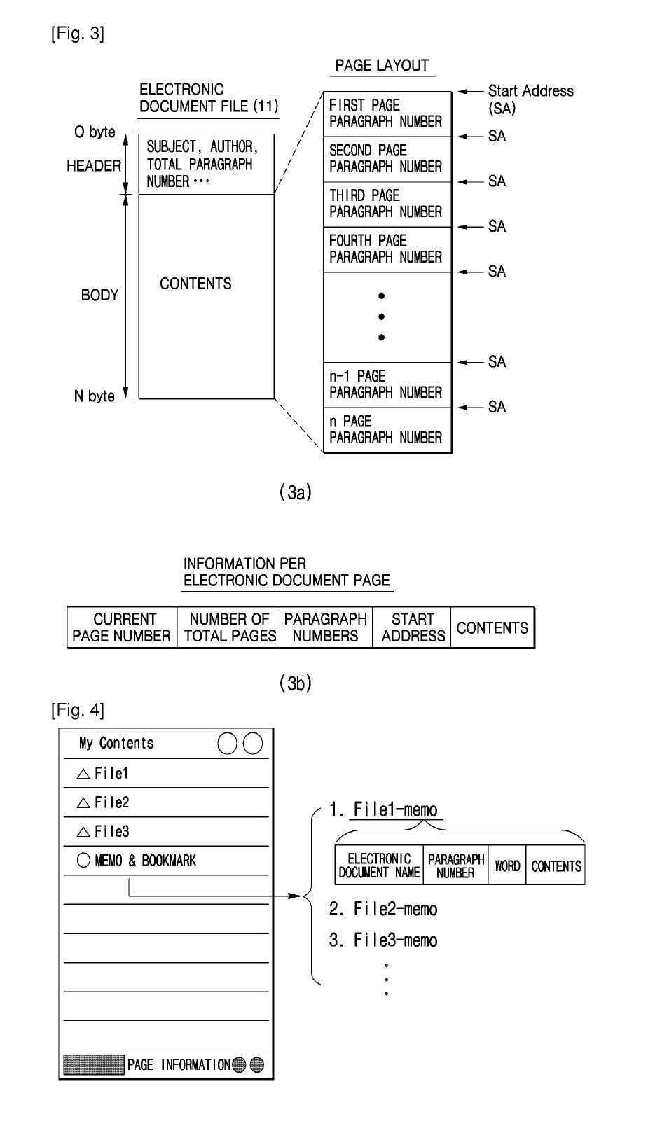

The layout generator (17-1) of the controller (17) may lay out per page the electronic document files stored in the electronic document storage (11-1) as shown in FIG. 3a according to pre-set layout information. The layout information such as the number of pages, letter sizes and line spaces displayed on one screen may be pre-set or adjusted by a user.

The layout information may be properly set up according to the types of terminals such as a desktop computer, a notebook, a handheld computer, a mobile phone employed exclusively for electronic documents and mobile phones like PDAs. For example, in a case electronic documents are provided from a personal computer like a desktop, content of 2 pages in large letters may be displayed on one screen, and in a case the electronic documents are provided from a mobile phone, content of 1 page in small letters on one screen may be displayed.

The electronic document displayed on the display means (13) of the electronic book (10) may 1 (one) page or 2 (two) or more pages according to the circumstance.

The files stored in the electronic document storage (11-1) may comprise a header including basic information such as subject, a writer name, date of writing, a total number of bytes, a total number of paragraphs and the publisher name, and a body comprised of body content, as shown in FIG. 3a.

The electronic documents per page laid out by the layout generator (17-1) may comprise at least any one or more of a page number, a total number of pages, paragraph numbers included in a relevant page, a start address (SA) and contents as shown in FIG. 3b. In a case a plurality of paragraphs is included in one page, all the relevant paragraph numbers are contained in the electronic documents per page. The page number is changed according to the layout changes but the paragraph number is not changed in layout thereof.

Furthermore, the memo information stored in the memo storage (11-2) includes electronic document names, paragraph numbers, memo subjected words and memo contents per list, and the memo information (files) of the electronic documents is formed in one folder structure, as illustrated in FIG. 4.

### Mode for the Invention

Now, the operational process of the electronic book (10) thus constructed will be described briefly.

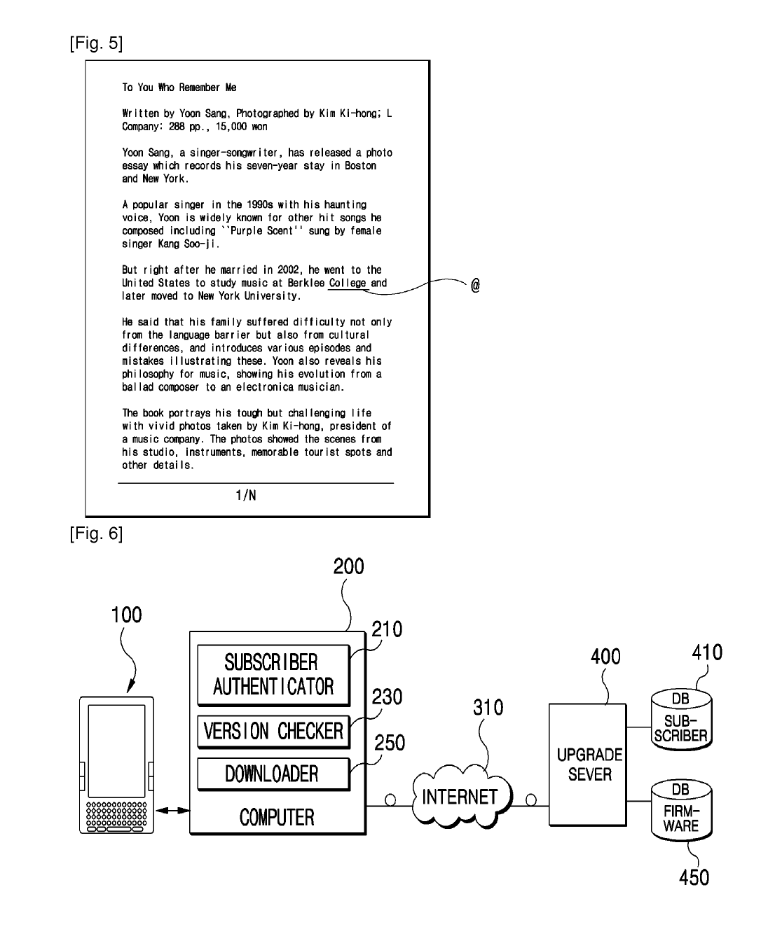

First, the controller (17) adjusts the electronic documents stored in the electronic document storage (11-1) in response to the command inputted through the input means (15) based on page layout standard pre-set by the layout generator (17-1), and displays a predetermined electronic document page on the display means (13) as illustrated in FIG. 5. At least one or more pages of the electronic document may be displayed on one screen based on the pre-set layout standard, where the number of pages displayable on one screen may be changed according to the type of terminal or user choice.

Successively, the memo maker (17-2) of the controller (17) may display the memo input window on the display means (13) in a case a memo preparation command is inputted from input means (15), and add the memo content inputted through the memo input window to the electronic document name, the paragraph number and a memo subjected word for storage in the memo storage (11-2).

Furthermore, the memo maker (17-2) may underline (@) the memo subjected word to visually show whether the word has been memo-ed or bookmarked, as shown in FIG. 5.

As noted in the present invention, a memo or a bookmarked portion is underlined, and the memo or bookmarked portion is remembered of its position through the paragraph number and the underlined word, and even if there is a plurality of electronic document files, an entire memo files can be managed or controlled in one folder structure.

As a result, because the electronic book manages multiple memo lists in one folder structure, it is possible to display in a lump the memo lists stored in the memo storage (11-2) on the display means (13), making the memo review efficient. In present invention, even if the letter size of the electronic document or line space is changed to thereby change the number of pages, the memo information can be memorized in paragraph number and word per page to thereby dispense with a separate memo or bookmark design, providing convenience with regard to management efficiency of the memo information and layout changes.

FIG. 6 is a schematic view illustrating a system for firmware upgrade according to another exemplary embodiment of the present invention, where the system may include an electronic book terminal (100), a computer (200) and upgrade server (400).

The electronic book terminal (100) transmits to the connected computer (200) terminal information, subscriber information and firmware version information, and in a case a version-up firmware is received from the computer (200), an automatic upgrade program is executed and installed. The terminal information is intrinsic identification information such as serial number or modem number, and the subscriber information is intrinsic information such as an ID (Identification), a password or residential registration number.

The computer (200) obtains the terminal information, the subscriber information and the firmware version information from the electronic book terminal (100) in a case the computer is connected to the electronic book terminal (100) and receives the subscriber information relative to the terminal information from the upgrade server (400) to check whether to match therebetween, and if it is determined to match therebetween, the computer (200) receives a latest firmware from the upgrade server (400) and transmits to the electronic book terminal (100).

The computer (200) receives version information of the latest firmware from the upgrade server (400) prior to downloading of the latest firmware from the upgrade server (400) to compare with a firmware version installed in the electronic book terminal (100), and requests download of the latest firmware from the upgrade server (400) if an upgrade of the firmware is necessary.

That is, the computer (200) includes a subscriber authenticator (210) comparing the subscriber information transmitted from the electronic book terminal with subscriber information of the terminal information transmitted from the upgrade server and determining whether to match therebetween; a version checker (230) comparing the firmware version transmitted from the electronic book terminal with the latest firmware version transmitted from the upgrade server and determining whether to need firmware upgrade; and a downloader (250) receiving the latest firmware from the upgrade server (400) to transmit to a relevant electronic book terminal (100) if upgrade is needed as a result of comparison of the firmware versions.

The upgrade server (400) transmits to the computer (200) the subscriber information matched to the terminal information of the electronic book terminal and version information of the latest firmware in response to the connected computer (200), and transmits a relevant latest firmware to the computer (200) in a case the download is requested from the computer (200) regarding the latest firmware. The upgrade server (400) is stored with terminal information of multiple users and subscriber information, where the terminal information of multiple users and the subscriber information are matched.

The electronic book terminal (100) may be a portable terminal, a mobile terminal, PDA or a mobile computer.

The electronic book terminal (100) and the computer (200) may be connected to a wired (e.g., USB interface) or a short distance wireless communication (e.g., wireless LAN, Bluetooth, UWB and Zigbee), where the computer (200) and the upgrade server (400) may be interconnected via internet (310). An IP address of the upgrade server (400) is pre-stored in the computer (200) to automatically drive a web browser and to be connected to the upgrade server (400) during firmware upgrade of the electronic book terminal (100).

That is, in a case the computer (200), upon reception of the terminal information and the subscriber information from the connected electronic book terminal (100), receives from the upgrade server (400) the subscriber information relative to the terminal information to determine whether the subscriber information relative to the terminal information is matched.

Furthermore, if the subscriber information is matched, the computer (200) compares the firmware version transmitted from the electronic book terminal (100) with the latest firmware version obtained from the upgrade server (400) and receives the latest firmware from the upgrade server (400) if the upgrade is needed and transmits to the electronic book terminal (100). As a result, the electronic book terminal (100) executes the automatic upgrade program and installs the downloaded latest firmware.

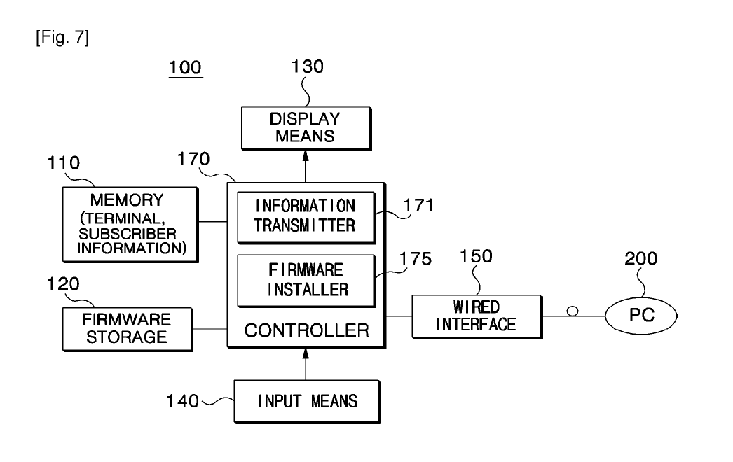

FIG. 7 is a block diagram illustrating detailed configuration of the electronic book terminal of FIG. 6 according to an exemplary embodiment of the present invention, where the electronic book terminal (100) may include a memory (110), firmware storage (120), display means (130), input means (140), wired interface (150) and a controller (170).

The memory (110) is stored with terminal information, subscriber information, firmware version information, an IP address of the upgrade server (400) or URL (Uniform Resource Locator) address, and various electronic documents. The terminal information may intrinsic identification information such as intrinsic serial number or modem number and the subscriber information may be an ID (identification), a password or a residential registration number.

The firmware storage (120) is stored with operation system software for executing fundamental functions and firmware such as application software for providing additional functions by being driven on the operation system software. The display means (130) displays various electronic documents and firmware upgrade related screen according to a control signal from the controller (170). The input means (140) includes a keypad for inputting various commands for controlling the firmware upgrade, the electronic document downloading and screen. The input means (140) may be a key board or a touch panel.

The wired interface (150) is a serial interface such as USB that performs a data communication by being wiredly connected to the computer (200). The wired interface (150) is a device for receiving firmware or a particular electronic document by being connected to the communication interface of the computer (200).

The controller (170) controls in such a manner that terminal information stored in the memory (110), subscriber information and the firmware version information are transmitted to the computer (200) via the wired interface (150) according to the request from the computer (200), and automatically executes the upgrade program and installs the upgrade program if a latest firmware is received from the computer (200).

The controller (170) may include an information transmitter (171) and a firmware installer (175).

The information transmitter (171) transmits the terminal information, the subscriber information and the firmware version information stored in the memory (110) to the computer (200) via the wired interface (150), and the firmware installer (175) executes and installs the automatic upgrade program if the latest firmware is received.

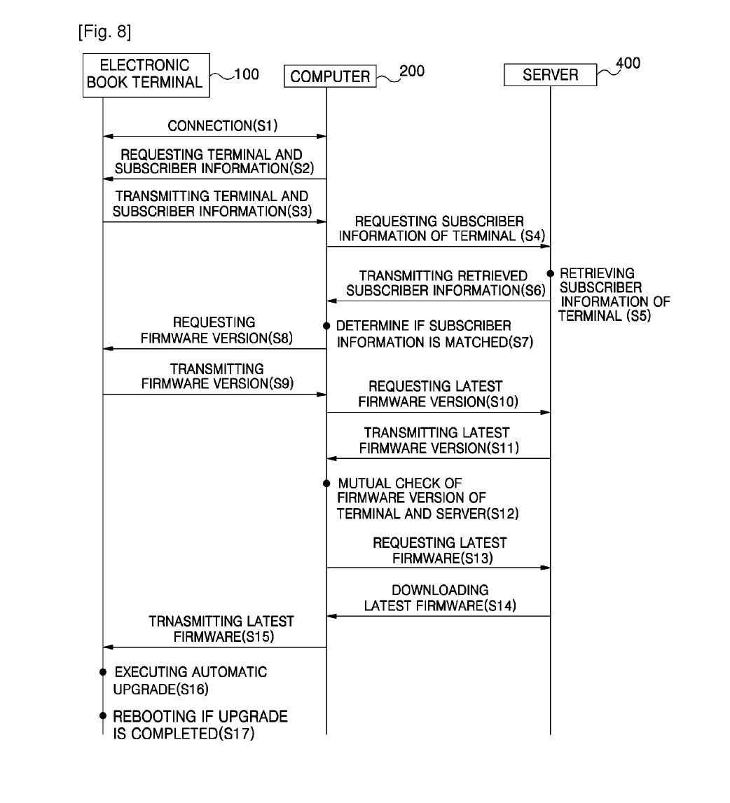

Now, operation process of the system for firmware upgrade thus configured will be explained with reference to FIG. 8.

First of all, the computer (200) requests the terminal information and the subscriber information from the electronic book terminal (100) if the electronic book terminal (100) is connected via the wired interface (150) (S1, S2). Successively, the electronic book terminal (100) transmits to the computer (200) via the wired interface (150) the terminal information such as intrinsic serial number or modem number of the terminal stored in the memory (110), and the subscriber information such as the ID, the password or the residential registration number.

Thereafter, the computer (200) requests the upgrade server (400) the subscriber information relative to the terminal information transmitted from the electronic book terminal (100) via internet (310) (S4).

The upgrade server (400) retrieves via database (410) the subscriber information relative to the terminal information requested from the computer (200) and transmits the retrieved subscriber information and the terminal information to the computer (200) (S5, S6).

Then, the computer (200) compares the terminal information and the subscriber information transmitted from the electronic book terminal (100) with the terminal information and the subscriber information transmitted from the upgrade server (400) to check if they are matched (S7), and requests version information relative to the firmware being used (S8) from the electronic book terminal (100) if they are matched.

As a result, the electronic book terminal (100) transmits the firmware version information stored in the memory (110) to the computer (200) via the wired interface (150) (S9). The computer (200) requests the version information relative to the latest firmware from the upgrade server (400) (S10), where the upgrade server (400) transmits to the computer (200) the version information relative to the latest firmware (S11).

The computer (200) compares the version relative to the latest firmware transmitted from the upgrade server (400) with the firmware version transmitted from the electronic book terminal (100) to check if they are matched (S12), and requests the latest firmware to the upgrade server (400) if upgrade is needed (S13).

The upgrade server (400) transmits the latest firmware to the computer (200), where the computer (200) transmits the latest firmware to a relevant electronic book terminal (100) (S14, S15). The electronic book terminal (100), upon receipt of the latest firmware from the computer (200), executes and installs an automatic upgrade program (S16), and temporarily displays a firmware upgrade status on the display means (130) if the installation is completed, and is automatically re-booted (S17).

Although FIG. 8 has described a sequential execution of the terminal information, subscriber information and firmware version checks via the electronic book terminal (100) and the upgrade server (400), it should be apparent that the terminal information, the subscriber information and firmware version information can be requested at once and checked in a lump.

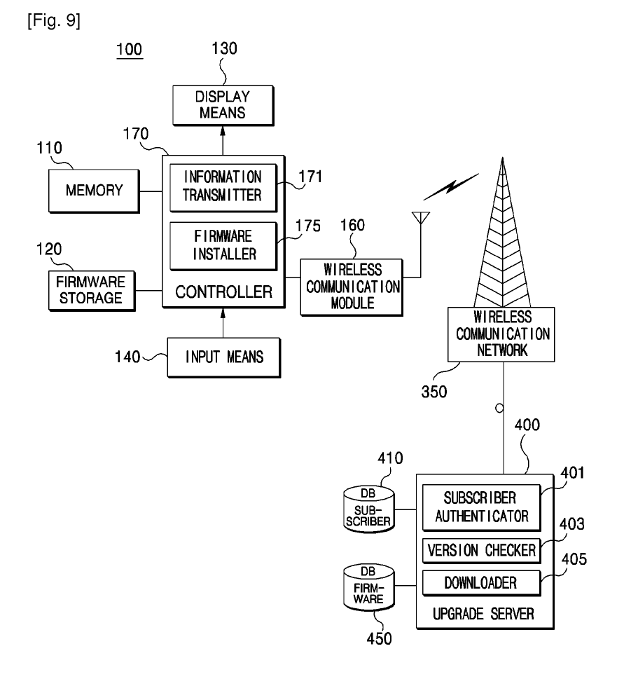

FIG. 9 is a schematic view illustrating a system for firmware upgrade according to another exemplary embodiment of the present invention, where the system may include an electronic book terminal (100), a wireless communication network (350) and an upgrade server (400).

The electronic book terminal (100) transmits the terminal information, the subscriber information and the firmware version information to the upgrade server (400) via the wireless communication network (350), and executes and installs an automatic upgrade program if the version-up firmware is transmitted from the upgrade server (400).

The electronic book terminal (100) may include a memory (110), display means (130), input means (140), a wireless communication module (160) and a controller (170).

The memory (110) is stored with terminal information, subscriber information, firmware version information, an IP address of the upgrade server (400) or URL (Uniform Resource Locator) address, and various electronic documents. The terminal information may be intrinsic identification information such as intrinsic serial number or modem number and the subscriber information may be an ID (identification), a password or a residential registration number.

The firmware storage (120) is stored with operation system software for executing fundamental functions and firmware such as application software for providing additional functions by being driven on the operation system software. The display means (130) displays various electronic documents and firmware upgrade related screen according to a control signal from the controller (170). The input means (140) includes a keypad for inputting various commands for controlling the firmware upgrade, the electronic document downloading and screen. The input means (140) may be a key board or a touch panel.

The wired communication module (160) is a 3G (third generation) or a 4G (fourth generation) modem unit that performs a wireless communication with the wireless communication network (350) to transmit the terminal information and the subscriber information to the upgrade server (400) and to receive a latest firmware from the upgrade server (400). The 3G is a mobile communication technique capable of downloading sounds, characters and images via a mobile phone, and bidirectional communication, downloading on-demand video, and MP3 via a wireless internet. The 4G is a technology of high quality transmission/reception of various types of multimedia information using the mobile communication network during stationary and mobile situations (1 Gbps in stationary situation and 100 Mbps in mobile situation).

The exemplary embodiment of the present invention has described 3G or 4G modem unit which connects the wireless communication module (160) to the upgrade server (400) via the wireless communication network (350), where the wireless communication module (160) may be a wireless LAN module or a Wibro module capable of connecting to the internet.

The controller (170) controls in such a fashion that the terminal information, the subscriber information and firmware version information stored in the memory (110) are transmitted to the upgrade server (400) through the wireless communication module (160), and automatically executes and installs an upgrade program in the firmware storage (120).

The controller (170) may include an information transmitter (171) and a firmware installer (175). The information transmitter (171) transmits the terminal information, the subscriber information and the firmware version information respectively stored in the memory (110) to the upgrade server (400) via the wireless communication module (160) in a case an upgrade command is inputted from the input means (140) or in a case a set-up upgrade period comes up, and the firmware installer (175) executes the automatic upgrade program and installs the program in the firmware storage (120) if the latest firmware is received.

The electronic book terminal (100) upgrades the firmware according to an upgrade command inputted from the input means (140) or the set-up upgrade period if the firmware is to be upgraded using the wireless communication module (160).

That is, the electronic book terminal (100) requests the upgrade by transmitting the terminal information, the subscriber information and the firmware version information stored in the memory (110) to the upgrade server (400) via the wireless communication network (350) if the firmware upgrade command is inputted from the input means (140) or the set-up upgrade period comes up, and automatically executes and installs the upgrade program if the latest firmware is transmitted from the upgrade server (400).

The wireless communication network (350) forms a wireless channel to connect the electronic book terminal (100) with the upgrade server (400) according to the IP address transmitted from the electronic book terminal (100). Although the wireless communication network (350) is not described in detail, the wireless communication network (350) may include a base station that receives book information from the electronic book terminal (100) and a base station controller controlling and managing at least one or more base stations to transmit the book information transmitted from each electronic book terminal (100) via the base station to PDSN (Packet Data Serving Node) or MSC (Mobile Switching Center). The wireless communication network (350) may include a gateway converting communication protocol between the wireless communication network (350) and the internet in a case the wireless communication network (350) is connected to the upgrade server (400) via the internet.

The upgrade server (400) compares with the subscriber information relative to the terminal information stored in database (410) in a case the terminal information, the subscriber information and the firmware version information are transmitted from the electronic book terminal (100) connected via the wireless communication network (350) to check if they are matched, and compares the firmware version installed in the electronic book terminal (100) with the latest firmware version if the subscribers are matched. As a result of the check, if the upgrade is needed, the upgrade server (400) transmits the latest firmware to the electronic book terminal (100) via the wireless communication network (350).

The upgrade server (400) may include includes a subscriber authenticator (401) comparing the subscriber information transmitted from the electronic book terminal with subscriber information of the terminal stored in subscriber database (410) to determine whether to match therebetween; a version checker (403) comparing the firmware version transmitted from the electronic book terminal (100) with the latest firmware version stored in firmware database (450) to determine whether to upgrade; and a downloader (405) extracting the latest firmware from the firmware database (450) in case of needing the upgrade as a result of comparison with the firmware version and transmitting to a relevant electronic book terminal (100).

The subscriber database (410) of the upgrade server (400) is stored with terminal information of a plurality of users and the subscriber information where the terminal information of a plurality of users and the subscriber information are matched.

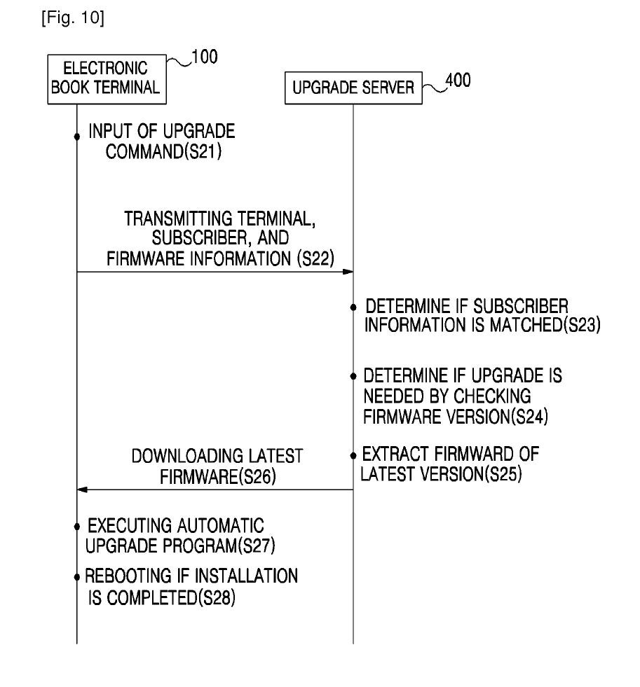

Now, the operational process of the system for firmware upgrade thus configured will be described with reference to the procedural view of FIG. 10.

First, the electronic book terminal (100) transmits the terminal information, the subscriber information and the firmware version information respectively stored in the memory (110) to the upgrade server (400) via the wireless communication module (160) in a case an upgrade request command is inputted from the input means (140) or in a case a set-up upgrade period comes up, thereby requesting the firmware upgrade (S21, S22). The terminal information may be intrinsic serial number or modem number and the subscriber information may be an ID (identification), a password or a residential registration number.

Successively, the upgrade server (400) receives the terminal information and subscriber information transmitted from the electronic book terminal (100) via the wireless communication network (350), and extracts the subscriber information relative to the terminal information from the subscriber database (410) to compare the subscriber information of the electronic book terminal (100) with the subscriber information stored in the subscriber database (410) and checks if they are matched (S23). If they are matched, the upgrade server (400) compares the latest firmware version stored in firmware database (450) with the firmware version transmitted from the electronic book terminal (100) to determine if there is needed any upgrade (S24).

The upgrade server (400) extracts the latest version of firmware from the firmware database (450) if the upgrade of the firmware of the electronic book terminal (100) is needed and transmits the latest firmware to a relevant electronic book terminal (100) (S25, S26). The electronic book terminal (100) executes and installs an automatic upgrade program (S27) if the latest firmware is downloaded from the computer (200), and if the installation is completed, the firmware upgrade status is temporarily displayed on the display means (130) and is automatically re-booted (S28).

Although FIG. 10 has described the checking of matching by receiving at once the terminal information, subscriber information and firmware version information from the electronic book terminal (100), it should be apparent that it is also possible to sequentially check by sequentially receiving the terminal information, the subscriber information and firmware version information.

If the terminal information and the subscriber information stored in the electronic book terminal (100) fails to match with the subscriber information relative to the terminal information stored in the subscriber database (410), the upgrade server (400) does not provide the service of upgrading the latest firmware, where the upgrade server (400) may transmit a message to the electronic book terminal (100) that the subscriber is not registered.

Although FIGS. 9 and 10 have described the connection of the electronic book terminal (100) to the upgrade server (400) through the wireless communication network (350), the wireless communication network (350) may be a mobile communication network or a Wibro network.

Although the present invention have been described with reference to a number of illustrative embodiments thereof, it should be understood that numerous other modifications and embodiments can be devised by those skilled in the art that which fall within the spirit and scope of the principles of this disclosure. More particularly, various variations and modifications are possible in the component parts and/or arrangements of the subject combination arrangement within the scope of the invention, the drawings and the appended claims. In addition to variations and modifications in the component parts and/or arrangements, alternative uses will also be apparent to those skilled in the art.

### INDUSTRIAL APPLICABILITY

The present invention is applicable to the industries in that the electronic book can manage a plurality of memo lists in one folder structure to enable a package display of the memo lists and an effective memo inspection.

The present invention is also applicable to the industries in that the memo information can be memorized per paragraph number and word unit to dispense with additional memo or bookmark design even if the number of pages is changed due to layout change of the electronic documents, thereby providing a management efficiency of memo information and convenience in the layout change.

The present invention is further applicable to the industries in that, in a case an electronic book terminal is accessed to a computer or an upgraded server, a firmware version stored in the terminal can be checked through a subscriber certification and if there is any upgrade of firmware, the firmware is automatically transmitted to the electronic book terminal to enable the latest firmware to be easily installed to the advantage of user convenience.

1. An electronic book, comprising:
an electronic document storage stored with electronic document files;
a memo storage stored with memo information per list including a memo or a bookmark content and position information thereof inputted based on the electronic documents; display means displaying the electronic documents per page; and
a controller controlling in such a manner that the electronic documents stored in the electronic document storage are laid out per page and displayed, and selectively receiving memo content of the displayed electronic documents, adding position information including a paragraph number of relevant electronic document to the inputted memo content and storing in the memo storage.

2. The electronic book of claim 1, wherein the position information includes at least any one of an electronic document name, a paragraph number and a memo subjected word.

3. The electronic book of claim 1, wherein the controller comprises:
a layout generator laying out per page the electronic documents stored in the electronic document storage based on a pre-set screen standard or a user set-up; and
a memo maker displaying a memo input window based on a memo making command inputted from outside, adding a memo content inputted through the memo input window to the electronic document name and the paragraph number, and storing in the memo storage.

4. The electronic book of claim 3, wherein the memo maker underlines a word to show whether the word is memo-ed or bookmarked.

5. The electronic book of claim 1, wherein the per-page laid-out electronic document includes a current page number, an entire page number, paragraph numbers of relevant page and start address information.

6. The electronic book of claim 1, wherein the electronic document storage and the memo storage are allocated in different region within one memory, and the memo storage is listed with memo information per electric document.

7. The electronic book of claim 1, further comprising input means that inputs a memo preparation, a memo input, and a page up/down command of the electronic document displayed on the display means.

8. The electronic book of claim 7, wherein the input means is a keypad or a touch panel.

9. A system for firmware upgrade of electronic book, comprising:
an electronic book terminal transmitting terminal information, subscriber information and version information of firmware to an accessed computer, and executing and installing an automatic upgrade program in a case version-up firmware is transmitted from the computer;
an upgrade server transmitting the subscriber information matching to terminal information of the electronic book terminal and latest firmware version information to the computer in response to the computer request and transmitting the latest firmware to the computer in a case the download is requested from the computer regarding the latest firmware; and
a computer obtaining terminal information, the subscriber information and firmware version information by requesting the terminal information, the subscriber information and the firmware version information to the electronic book terminal in a case the electronic book terminal is connected, receiving the subscriber information of the terminal from an upgrade sever to check whether the subscriber information is matched, and receiving a latest firmware from the upgrade server if the subscriber information is matched, and downloading to the electronic book terminal.

10. The system of claim 9, wherein the terminal information comprises at least any one of a serial number of the terminal and modem number, and the subscriber number comprises at least any one of an ID (identification), a password and a residential registration number.

11. The system of claim 9, wherein the computer receives version information of the latest firmware from the upgrade server before downloading the latest firmware from the upgrade server to compare the version information of the latest firmware with firmware version of the electronic book terminal, and request the download of the latest firmware from the upgrade server if needs be.

12. The system of claim 9, wherein the computer comprises:
a subscriber authenticator comparing the subscriber information transmitted from the electronic book terminal with subscriber information of the terminal transmitted from the upgrade server and determining whether to match therebetween;
a version checker comparing the firmware version transmitted from the electronic book terminal with the latest firmware version transmitted from the upgrade server and determining whether to match therebetween; and
a downloader receiving the latest firmware from the upgrade server to transmit to a relevant electronic book terminal if upgrade is needed as a result of comparison of the firmware versions.

13. The system of claim 9, wherein the upgrade server is stored with terminal information of a plurality of users and the subscriber information where the terminal information of a plurality of users and the subscriber information are matched.

14. The system of claim 9, wherein the electronic book terminal comprises:
a memory stored with terminal information, subscriber information, firmware version information, an IP address of the upgrade server or URL (Uniform Resource Locator) address, and various electronic documents;
a firmware storage stored with operation system software for executing fundamental functions and firmware such as application software for providing additional functions by being driven on the operation system software; display means displaying various electronic documents and firmware upgrade related screen according to a control signal from the controller;
a wired interface receiving firmware or various electronic documents by being wiredly connected to the computer; and
a controller controlling in such a manner that terminal information, subscriber information and the firmware version information stored in the memory are transmitted to the computer via the wired interface during the firmware upgrading, and automatically executing a upgrade program and installing the upgrade program if a latest firmware is received from the computer.

15. The system of claim 14, wherein the controller comprises:
an information transmitter transmitting the terminal information, the subscriber information and the firmware version information stored in the memory to the computer via the wired interface by the computer request; and
a firmware installer executing and installing an automatic upgrade program in the firmware storage if the latest firmware is received from the computer.

16. A system for firmware upgrade of electronic book, comprising:
an electronic book terminal connecting to an upgrade server through a wireless communication network and transmitting the stored terminal information, the subscriber information and firmware version information to an upgrade server to request a firmware upgrade, and executing and installing an automatic upgrade program in a case the version-up firmware is transmitted from the upgrade server; and
the upgrade server comparing the subscriber information from the electronic book terminal with the subscriber information of the terminal stored in the database in a case the terminal information, the subscriber information and the firmware version are transmitted from the electronic book terminal and checking whether to match therebetween, and comparing the firmware version installed in the electronic book terminal with a latest firmware version if the subscriber information is matched, and transmitting the latest firmware to the electronic book terminal if there is any need of upgrading.

17. The system of claim 16, wherein the upgrade server comprises:
a subscriber authenticator comparing the subscriber information transmitted from the electronic book terminal with subscriber information of the terminal stored in the database and determining whether to match therebetween;
a version checker comparing the firmware version information transmitted from the electronic book terminal with the latest firmware version stored in the database and determining whether to match therebetween; and
a downloader extracting the latest firmware from the database to transmit to a relevant electronic book if upgrade is needed as a result of comparison of the firmware versions.

18. The system of claim 16, wherein the electronic book terminal comprises:
a memory stored with terminal information, subscriber information, firmware version information, an IP address of the upgrade server or URL (Uniform Resource Locator) address, and various electronic documents;
a firmware storage stored with operation system software for executing fundamental functions and firmware such as application software for providing additional functions by being driven on the operation system software;
display means displaying various electronic documents and firmware upgrade related screen according to a control signal;
input means inputting various commands for the firmware upgrade and the screen control;
a wireless communication module performing a wireless communication with wireless communication network to transmit the terminal information, the subscriber information, and the firmware version information to the upgrade server, and downloading a latest firmware from the upgrade server; and
a controller controlling in such a manner that terminal information, subscriber information and the firmware version information stored in the memory are transmitted to the upgrade server via the wireless communication module during the firmware upgrading, and automatically executing a upgrade program and installing the upgrade program in the firmware storage if the latest firmware is received from the upgrade server.

19. The system of claim 18, wherein the controller comprises:
an information transmitter transmitting the terminal information, the subscriber information and the firmware version information stored in the memory to the upgrade server via respective wireless communication modules if an upgrade command is inputted from the input means; and
a firmware installer executing and installing an automatic upgrade program in the firmware storage if the latest firmware is received from the upgrade server.
